(19) United States
(12) Patent Application Publication
(10) Pub. No.: US 2017/0288941 A1
(43) Pub. Date: Oct. 5, 2017

(54) METHOD AND SYSTEM FOR MANAGING SERVERS ACROSS PLURALITY OF DATA CENTRES OF AN ENTERPRISE

(71) Applicant: Wipro Limited, Bangalore (IN)

(72) Inventor: Jacob MATHEW, Bangalore (IN)

(73) Assignee: Wipro Limited

(21) Appl. No.: 15/085,328

(22) Filed: Mar. 30, 2016

(30) Foreign Application Priority Data
Mar. 29, 2016 (IN) 201641010907

(51) Int. Cl. H04L 12/24

(52) U.S. Cl. CPC H04L 41/042; H04L 41/0866; H04L 41/0823

(57) ABSTRACT

The present disclosure relates to a method and system for managing the servers across a plurality of data centres of an enterprise. The servers of the plurality of data centres are managed by a server management system. The server management system obtains the server related data and network related data of a plurality of data centres and correlates the obtained server related data with the network related data to determine communication data. The communication data is used for generating a communication matrix which represents a relationship between the servers. Based on the communication matrix, the server management system creates one or more views of the servers to manage the servers of the plurality of data centres.

### FIELD OF THE INVENTION

The present subject matter is related in general to management of data centres, more particularly, but not exclusively to a method and system for managing servers across plurality of data centres of an enterprise.

### BACKGROUND

With the rapidly evolving Information Technology and huge amount of applications, effective management of data centres has become one of the prime areas of concerns. Each enterprise of software industry comprises numerous servers which are stored in the various data centres of the enterprises. The various servers in-turn relate and have dependency with various other servers in the data centres. However, with the multiple data centres in the organization and numerous servers spanning across, management of the servers across multiple data centres of an enterprise has become very difficult.

In the current scenario, the enterprise identifies the dependency or the relationship between the servers and of applications in the servers by deploying sophisticated third party tools. However, these third party tools are very time consuming and also intrusive for many users. In addition, for example, the third party tools requires sophisticated skills, agent installation, remote registry, access etc., and generates a lot of discovery traffic in the data centres which requires downtime. Also, multiple servers in the enterprises comprise numerous applications and data. These applications and data in the enterprises continue to increase, and thereby cause the addition of servers in the enterprise. The addition of servers create extra infrastructure while increasing the information technology landscape, which in-turn increases the budget of the enterprise exponentially.

Thus, in the existing scenario, management of the servers in the data centres has become one of the most difficult tasks. Also, the existing technology increases the information technology budget by adding additional servers to the data centres for hosting and storing huge amount of applications. Thus, the number of the servers needs to be consolidated to work efficiently. In order to do so, the duplicated servers and applications have to be removed from the multiple servers, which require a clear dependency data between the servers. Consequently, there is a need for a method for managing the servers across plurality of data centres of an enterprise effectively.

### SUMMARY

In an embodiment, the present disclosure relates to a method for managing servers across plurality of data centres of an enterprise. The method comprises retrieving server related data and network related data from a plurality of data centres, correlating the server related data with the network related data to obtain communication data, generating a communication matrix based on the communication data. The communication matrix represents a relationship between the servers across the plurality of data centres. The method comprises creating one or more views of the servers of the plurality of data centres based on the identified communication matrix to manage the servers across the plurality of data centres.

In an embodiment, the present disclosure relates to a server management system for managing servers across plurality of data centres of an enterprise. The server management system comprises a processor and a memory communicatively coupled to the processor, wherein the memory stores processor executable instructions, which, on execution, causes the server management system to retrieve server related data and network related data from a plurality of data centres, correlate the server related data with the network related data, to obtain communication data, generate a communication matrix based on the communication data. The communication matrix represents a relationship between the servers across the plurality of data centres. The server management system creates one or more views of the servers of the plurality of data centres based on the identified communication matrix to manage the servers across the plurality of data centres.

In an embodiment, the present disclosure relates to a non-transitory computer readable medium including instructions stored thereon that when processed by at least one processor cause a server management system to retrieve server related data and network related data from a plurality of data centres, correlate the server related data with the network related data to obtain communication data, generate a communication matrix based on the communication data, wherein the communication matrix represents a relationship between the servers across the plurality of data centres and create one or more views of the servers of the plurality of data centres based on the identified communication matrix to manage the servers across the plurality of data centres.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary environment for managing servers across the plurality of data centres in accordance with some embodiments of the present disclosure;

FIG. 2a shows a detailed block diagram illustrating a server management system in accordance with some embodiments of the present disclosure;

FIG. 2b shows an exemplary environment illustrating data flow between different modules of server management system in accordance with some embodiment of the present disclosure;

FIG. 2c shows an exemplary environment illustrating a visual output of what-if analyser in accordance with some embodiment of the present disclosure;

FIG. 2d shows an exemplary representation illustrating a data flow view of servers in accordance with some embodiment of the present disclosure;

FIG. 2e shows an exemplary representation illustrating a logical view of data centre in accordance with some embodiment of the present disclosure;

FIG. 2f shows an exemplary representation illustrating a topology view of servers in accordance with some embodiment of the present disclosure;

FIG. 3 illustrates a flowchart showing a method for managing the servers across plurality of data centres in accordance with some embodiments of present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure relates to a method for managing servers across a plurality of data centres of an enterprise. The method provides one or more views of the servers based on the server related and network related data. The present disclosure provides a server management system which creates one or more views of the servers based on a communication matrix to aid in managing the servers of the plurality of data centres. The one or more views of the servers help in managing the servers across the plurality of data centres by depicting a clear communication relationship between the servers. In an embodiment, the communication matrix represents a relationship between the servers across the plurality of data centres. The present disclosure retrieves the server related data as well as network related data in order to generate a communication matrix. The present disclosure discloses assessing the dependency mapping between servers with and across data centres, bandwidth for the servers of the plurality of data centres and determining the effective data centres migrations. In such a way, one or more views are created for the servers which depict a clear dependency relationship across the plurality of data centres of an enterprise. This helps in building effective visualization of relationship between servers for efficient management of the servers.

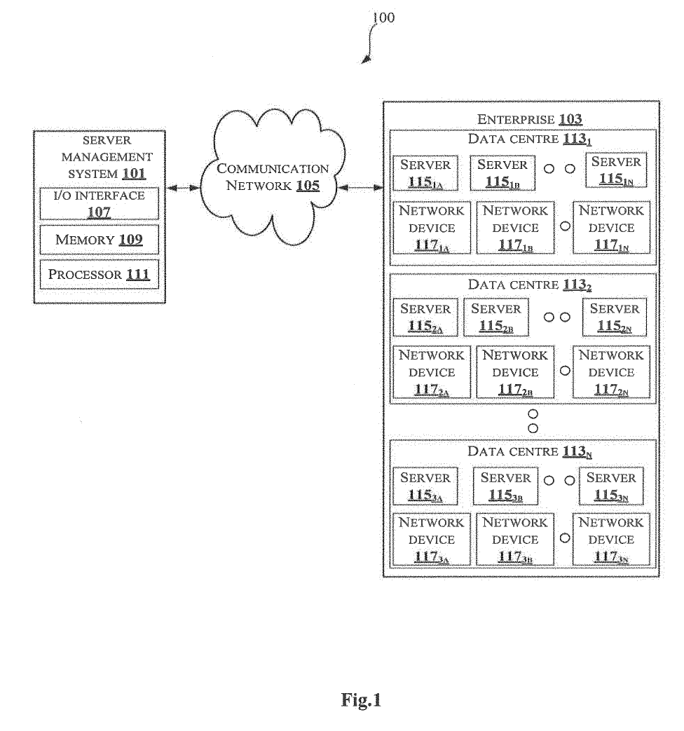

FIG. 1 illustrates an exemplary environment for managing the servers across the plurality of data centres in accordance with some embodiment of the present disclosure.

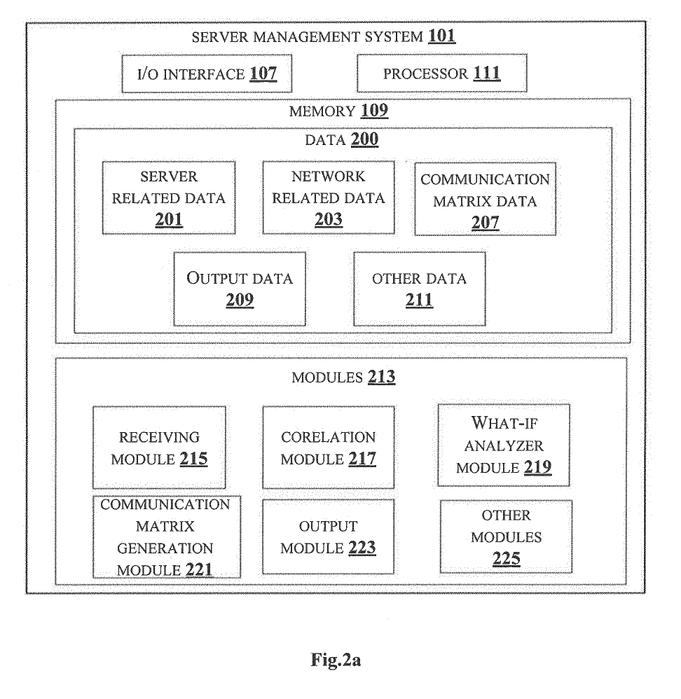

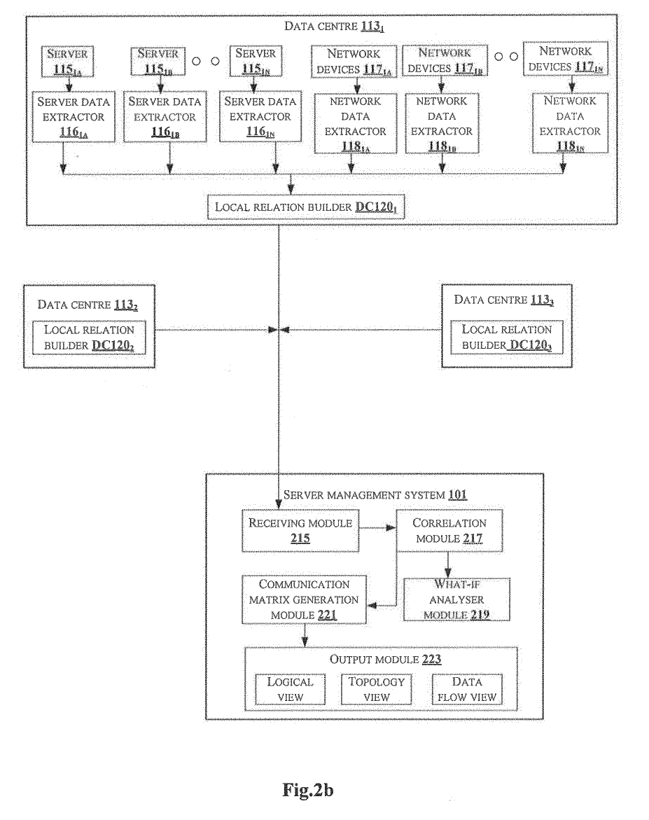

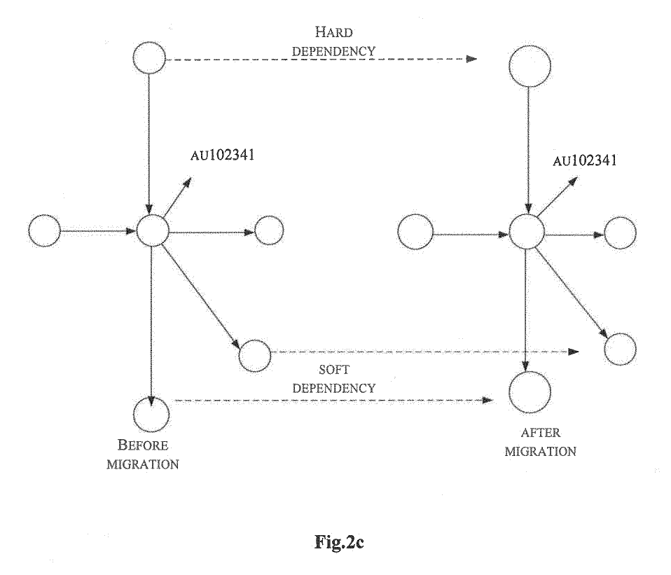

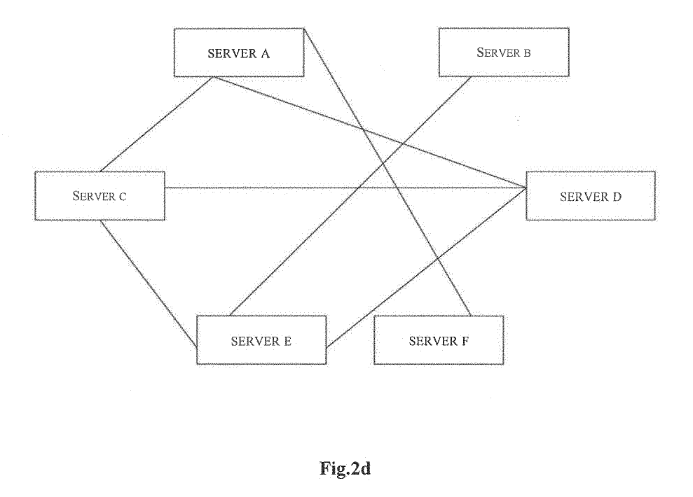

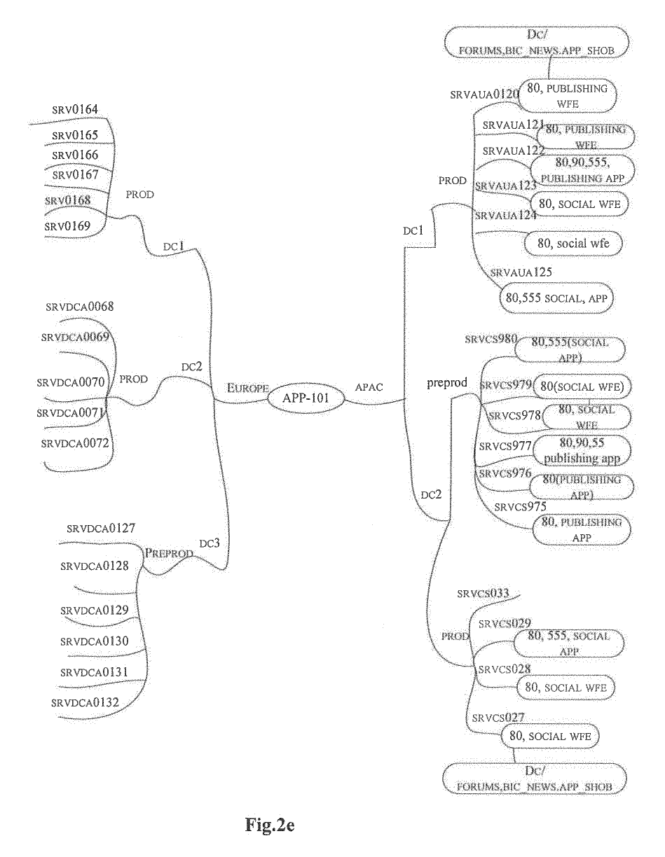

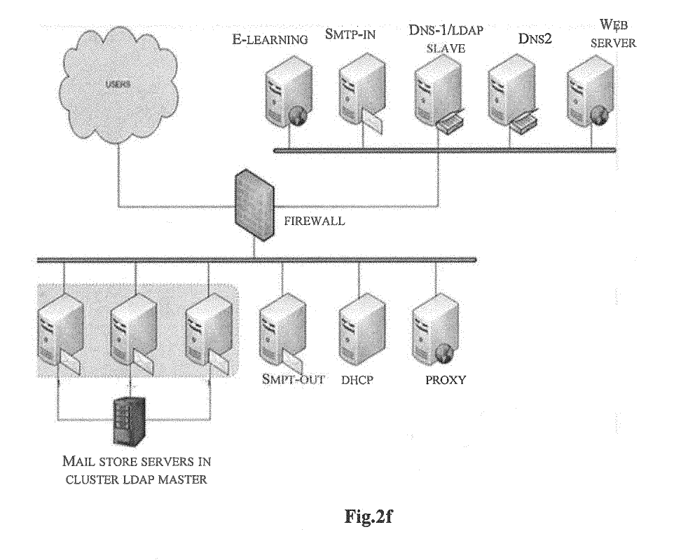

As shown in FIG. 1, the environment 100 comprises a server management system 101 and an enterprise 103 connected through a wired or wireless communication network 105. The enterprise 103 comprises a data centre 113₁, data centre 113_{2,} . . . data centre 113_{N} (collectively referred to as plurality of data centres 113). The data centres 113₁, comprises a server 115_{1A}, server 115_{B1}, . . . server 115_{1N} and a network device 117_{1A}, network device 117_{1B}, . . . network device 117_{1N}. In an embodiment, the other plurality of data centres 113 also comprises servers and network devices as shown in FIG. 1. The servers and network devices of the plurality of data centres 113 are collectively referred as servers 115 and network devices 117 respectively. In an embodiment, a data centre typically encompasses computer systems, physical infrastructure to host the computer systems, telecommunication and storage system, backup power supplies, data communication connections, environmental controls like air conditioning, fire suppression and various security devices etc. The server management system 101 retrieves the server related data and also the network related data from the servers 115 and the network devices 117 of the plurality of data centres 113 of the enterprise 103 respectively. In an embodiment, the network devices 117 in the plurality of data centres 113 comprise routers, switches, firewall etc. A person skilled in the art would understand that any other network devices can be used in the plurality of data centres 113. The server related data comprises information about communication paths used by the servers, connections between the servers like Transmission Control Protocol (TCP) connections, User Datagram Protocol (UDP) connections, time-wait connections, source and destination port information, executable responsible for connection establishment, interfaces and current configurations of the servers, inter server dependencies and storage of the servers etc. The network related data obtained by the server management system 101 comprises at least one of traffic flow pattern, firewall traffic, load balancer traffic which comprises information of cumulative input and output data of servers, number of sessions per servers, least connected servers, most connected servers etc. In an embodiment, the server related data also comprises information on storage, backup devices and other non-standard IT devices within the plurality of data centres 113. The network related data also comprises routing data, virtual switch information and physical switch traffic which include network device information and network connection information etc. The server related data from the servers 115 of the of data centres 113₁, are extracted by a server data extractor 116_{1A}, server, data extractor 116_{1B,} . . . server data extractor 116_{1N} (shown in FIG. 2b). The plurality of data centres 113 comprises the server data extractor corresponding to the servers 115. In an embodiment, the server data extractor corresponding to the servers 115 of the plurality of data centres 113 are collectively referred to as server data extractor 116. In an embodiment, the server data extractor 116 comprises logic/command which captures the various communications within and passing through the particular server. The server data extractor 116 is usually deployed on the servers 115 and coded in the native language, depending on the type of operating systems used at the servers 115. Similarly, in an embodiment, the network related data from the network devices 117 of the data centre 113₁ are extracted by a network data extractor 118_{1A,} network data extractor 118_{1B,} . . . , network data extractor 118_{1N} (shown in FIG. 2b). The plurality of the data centres 113 comprises the network data extractors corresponding to the network devices 117. In an embodiment, the network data extractors of the plurality of data centres 113 are collectively referred to as network data extractors 118. The network data extractors 118 extract the network related data through a number of protocols. In an exemplary embodiment, a protocol to extract the network related data from network devices 117 comprises SNMP protocol etc. The extracted network related data may comprise, for example, bandwidth consumed between two servers, application specific bandwidth consumption, dropped packets, interfaces errors, session table etc., associated with the plurality of data centres 113. The server related data from the server data extractors 116 and the network related data from the network data extractors 118 are received by a local relation builder (as shown in FIG. 2b) present in the plurality of the data centres 113. In an embodiment, the local relation builder is present in the plurality of data centres 113 and is collectively referred as local relation builder 120. The local relation builder 120 parses the server related and network related data received from the plurality of data centres 113 and further builds various relations within the data centres. In an embodiment, the local relation builder 120 gathers intra data centres dependencies. Further, the server related data obtained is correlated with the network related data. In an embodiment, the correlated data provides communication data which comprises for example, source IP address, destination IP address, port on which communication took place, amount of data transferred etc. The server management system 101 further generates a communication matrix, which is a matrix defining the relationships between servers 115 across the plurality of data centres 113. In an embodiment, the generation of the communication matrix comprises carrying out a de-duplication process in order to remove redundant server and network related data. The server management system 101 then creates one or more views of the servers 115 of the plurality of data centres 113. In an embodiment, the one or more views comprises logical application flow view, physical topology view, data flow views etc. The server management system 101 determines effectiveness of migrations for the plurality of data centres 113 and performs bandwidth assessment based on the server and network related information.

The server management system 101 comprises an I/O Interface 107, a memory 109 and a processor 111. The I/O interface 107 is configured to receive the server related data and the network related data from the plurality of data centres 113 of the enterprise 103.

The received information from the I/O interface 107 is stored in the memory 109. The memory 109 is communicatively coupled to the processor 111 of the server management system 101. The memory 109 also stores processor instructions which cause the processor 111 to execute the instruction in order to manage the servers 115 across the plurality of data centres 113.

FIG. 2a shows a detailed block diagram illustrating a server management system in accordance with some embodiments of the present disclosure.

One or more data 200 and one or more modules 213 of the server management system 101 are described herein in detail. In an embodiment, the one or more data 200 comprises server related data 201, network related data 203, communication matrix data 207, output data 209 and other data 211 for managing the servers across the plurality of data centres 113 of an enterprise 103.

The server related data 201 comprises at least one of information about communication paths used by the servers, connections between the servers for example, TCP connections, UDP connections, time-wait connections etc., interfaces and current configurations of the servers, connected source and destination port address information, inter server dependencies and storage of the servers 115 of the plurality of data centres 113. The server related data is obtained by the server data extractor 116 corresponding to each of the servers 115. The server related data 201 helps in identifying the various communications within each of the data centres and also between the plurality of data centres 113. The storage of the servers 115 include storage network which comprise Storage Area Network (SAN) switches, storage hardware, backup sub systems, enterprise vault, archive systems, primary storage for servers and tape systems.

The network related data 203 comprises at least one of traffic flow pattern firewall traffic, routing data, load balancer traffic. The load balancer traffic comprises for example, cumulative input and output data for various servers, number of sessions per servers, most connected and least connected servers etc. Further, the network related data comprises virtual switch and physical switch traffic which includes network device information and network connection information of the network devices 117 of the plurality of data centres 113. The network related data is obtained from the network data extractor placed in each of the network devices 117. The network related data 203 further comprises information on number and location of network ports in use and the network traffic associated with each of the network devices 117.

The communication matrix data 207 comprises information about the communication matrix generated from the communication data. In an embodiment, the communication matrix data 207 helps in planning the introductions of any new applications as well as shifting any of the applications in the plurality of data centre 113 of the enterprise 103. Further, the communication data 207 also comprises firewall rules which are needed for controlling the communication between various servers 115 in orderly fashion.

The output data 209 comprises one or more views created for the servers 115 of the plurality of data centres 113. The views are can include, but are not limited to, logical application flow view, physical topology view or even a data flow. In an embodiment, the one or more views help the enterprise 103 for planning effective migrations, capacity assessment etc., to manage the servers of the plurality of data centres 113 efficiently.

The other data 211 may store data, including temporary data and temporary files, generated by modules for performing the various functions of the server management system 101.

In an embodiment, the one or more data 200 in the memory 109 are processed by the one or more modules 213 of the server management system 101. As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. The said modules when configured with the functionality defined in the present disclosure will result in a novel hardware.

In one implementation, the one or more modules 213 may include, for example, a receiving module 215, a correlation module 217, a what-if analyser module 219, a communication matrix generation module 221, and an output module 223. FIG. 2b shows an exemplary environment illustrating data flow between different modules of the server management system 101 in accordance with some embodiment of the present disclosure.

The one or more modules 213 may also comprise other modules 225 to perform various miscellaneous functionalities of the server management system 101. It will be appreciated that such aforementioned modules may be represented as a single module or a combination of different modules.

The receiving module 215 receives the server related data and the network related data from the plurality of data centres 113 of the enterprise 103. The server related data and the network related data are extracted by the server data extractors 116 and the network data extractors 118 of the corresponding servers 115 and network devices 117 respectively.

The correlation module 217 correlates the server related data with the network related data received by the receiving module 215 to obtain a communication data. The obtained communication data comprises communication information of the servers 115 for example, source IP address, destination IP address, ports in which communication took place, amount of data transferred etc. The correlation module 217 correlates the server related data for example, the server communication data with the corresponding data of the network devices 117.

The what-if analyser module 219 analyses the communication data associated with the servers 115 of the plurality of data centres 113. The what-if analyser analyses the dependency information of the servers 115 and traffic information of the network devices 117. The what-if analyser module 219 receives data from local relation builders 120 of the plurality of data centres 113 through the receiving module 215. In an embodiment, the local relation builder 120 provides relationship data of the plurality of data centres 113 which helps in performing various what-if analysis scenarios. For example, a server moving from one data centre to another implies movement of the traffic related to that particular server to the new data centres which includes storage traffic, network traffic and external communication traffic. As the relationship data is already captured using local relation builders 120 and receiving module 215, the same data is in-turn used by the what-if analyser module 219 to figure out what additional resources need to be provisioned to move the new server at the destination as shown in the below table.

TABLE 1

| Server | AU102341 | App hint: webapps; | | |
|---|---|---|---|---|
| IBD | OBD | HD | ADBWNW | COMMATRIX |
| 10.0.0.1; | 202.88.1.3; | AD, BKUP, | 1G; 4G | Open |
| 192.168.1.1 | 8.4.3.1; | TWS | | TCP53; |
| | 10.8.1.2 | | | UDP53; |
| | | | | RCP3588 |

The what-if analysis of the table above (Table 1) is as follows.

For Server AU102341 which hosts webapps if moved to a different data center will have.
a. Inbound dependencies from IP address 10.0.0.1 and 192.168.1.1
b. Outbound dependencies to IP address 202.88.1.3, 8.4.3.1 and 10.8.1.2
c. The firewall should allow traffic to ports TCP/UDP53, RCP3588 when migrated
d. Hard dependencies which needs to be addressed at target includes Active directory, backup and workload scheduler.

Further, the what-if analyser module 219 helps in completely eliminating human errors which may occur during complex data centre migrations. In such case, the what-if analyser module 219 generates inbound dependencies, outbound dependencies, hard dependencies, bandwidth requirement and communication matrix. The what-if analyser module 219 further helps in various transformation scenarios like consolidation of servers, migration of instances to cloud, bandwidth reduction between data centres etc., for managing the servers effectively in the plurality of data centres 113. In an embodiment, the what-if analyser module 219 also helps in shutting down of the various servers/network devices 117 for maintenance etc. The shutting down of the various servers/network devices 117 help in planning downtimes for the servers within and between the plurality of data centres 113. The what-if analyser module 219 also generates visual output for effective migration of servers. The visual output is generated by the what-if analyser module 219 from the data obtained from local relation builders 120 and receiving module 215. This data helps in identifying what communication needs to be re-established and what new resources need to be provisioned. Further, the what-if analyser module 219 converts the relationship data into node data, which in-turn is used for creating a visual output. The visual output leverages the force directed graph. The generated visual output provides information on dependencies which would break when a server is moved from one data centre to another and also the relations, which need to be rebuilt for its normal operations. FIG. 2c shows an exemplary environment illustrating a visual output of what-if analyser in accordance with some embodiment of the present disclosure. Further, the what-if analyser module 219 determines dependencies which cannot be broken so that the planning can be done to move such servers together. The what-if analyser module 219 also helps in figuring out bandwidth when a server is moved from one place/data centre to another henceforth capacity planning/provisioning can be done.

The communication matrix generation module 221 generates the communication matrix from the communication data. In an embodiment, the communication matrix helps in cases such as, moving/creating assets/applications, from and to a plurality of data centres 113. The communication matrix generation module 221 carries out a de-duplication process in order to remove the redundant information from the output of the correlation module 217. In a non-limiting embodiment, the de-duplication process is carried out by using a map-reduce algorithm. In an embodiment, the redundant information which shows identical relationships between the servers 115 is associated with a single application. The communication matrix generation module 221 carries out the de-duplication process by identifying and simultaneously storing unique pieces of server related data and further comparing the stored pieces of the server related data. Further, the communication matrix generation module 221 replaces the redundant data with a small reference that points to the stored pieces of server related data, whenever a match occurs from the comparison. This process in-turn provides clear information identifying which servers are related to each other and a communication matrix is constructed. The communication matrix describes a relationship between the interacting servers and those that may be standalone servers. In an embodiment, a standalone server is a server which is not connected with any other servers 115. The table below shows an example of communication matrix.

TABLE 2

| | | | | |
|---|---|---|---|---|
| Server 1 | Server 2 | Server 3 | Server N | Server X |
| Server N | Server 1 | Server 33 | Server 45 | Server X |
| Server 2 | Server N | Server 1 | Server 3 | Server X |
| Server 77 | Server 56 | Server 44 | Server 1 | Server X |

In the Table 2, the relationship/communication matrix among N numbers of servers is constructed by removing the redudant server related data which indicates the similar interaction paths. In the table 1, server 1 is communicating with server N, server 2 and server 77. Similarly server 2, server 3, server N and server X (numbers of server columns) are shown in the table 2, indicating their connections with other servers in the plurality of data centres 113. Further, server X as shown in Table 2 has no connection with any other servers and is therefore referred as the standalone server. In an embodiment, the standalone servers can be easily be decommissioned migrating its applications to another server with connections so as to use the data centres optimally. Further, the communication matrix generation module 221 also generates firewall rules which need to be incorporated to control communication between various servers in an orderly fashion. This helps in finding overall rules which replaces other rules in a firewall. In an embodiment, the generated rules help security administrators to generate the right rule for the network devices 117, thereby avoiding human error. The generated rules thus help in finding out what rules need to be added in different types of network devices 117 like router, switch, firewall, load balancer etc. The examples of firewall rules are as shown below:

permit 4.2.3.2 to 10.0.3.5 port 80,

permit 1.1.1.4 to 100.0.3.2 port 3128,

permit 100.1.1.0/24 to 192.168.1.0/24 any.

The output module 223 outputs the one or more views of the servers 115 of the plurality of data centres 113. In an embodiment, the one or more views are outputted by using methodologies like Force Directed Graph (FDG). In an embodiment, the force directed graphs are a class of algorithm which draws graphs in two dimensional/three dimensional space, so that all the depicted edges in the graph are of equal length. The one or more views may be in the form of, without any limitation, logical application flow view, physical topology view, a data flow view etc. The one or more views are provided as a visual graphical output. FIG. 2d shows an exemplary representation illustrating a data flow view of the servers in accordance with some embodiment of the present disclosure. In an embodiment, FIG. 2c shows a data flow between various servers like server A, server B, server C, server D, server E and server F. The servers in the FIG. 2c are treated as nodes or edges and the links are the forces between the servers. FIG. 2e shows an exemplary representation illustrating a logical view of the data centre in accordance with some embodiment of the present disclosure. FIG. 2f shows an exemplary representation illustrating a topology view of the servers in accordance with some embodiment of the present disclosure.

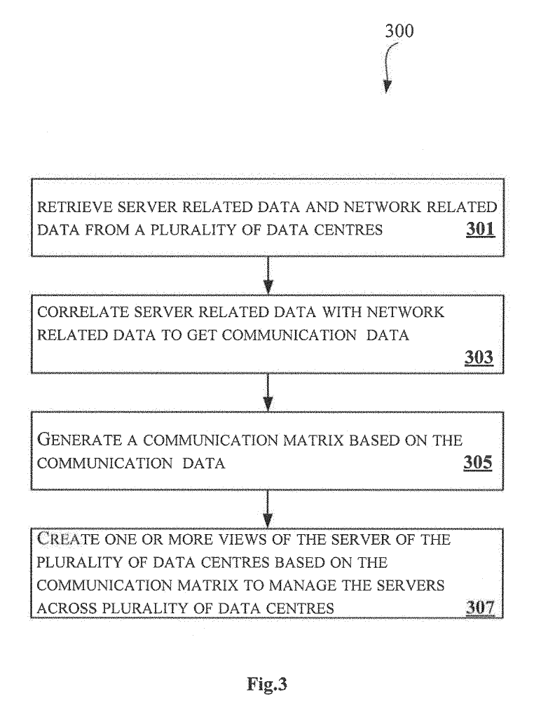

FIG. 3 illustrates a flowchart showing a method for managing the servers across plurality of data centres in accordance with some embodiments of present disclosure.

As illustrated in FIG. 3, the method 300 comprises one or more blocks for managing servers across plurality of servers of an enterprise. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, the server management system 101 retrieves server related data and network related data from plurality of data centres 113.

At block 303, the server management system 101 correlates the servers related data with the network related data to obtain communication data.

At block 305, the server management system 101 generates a communication matrix based on the communication data. The communication matrix represents a relationship between the servers across the plurality of data centres 113.

At block 307, the server management system 101 creates one or more views of servers of the plurality of data centres 113 based on the communication matrix to manage the servers of the plurality of data centres 113.

### Computing System

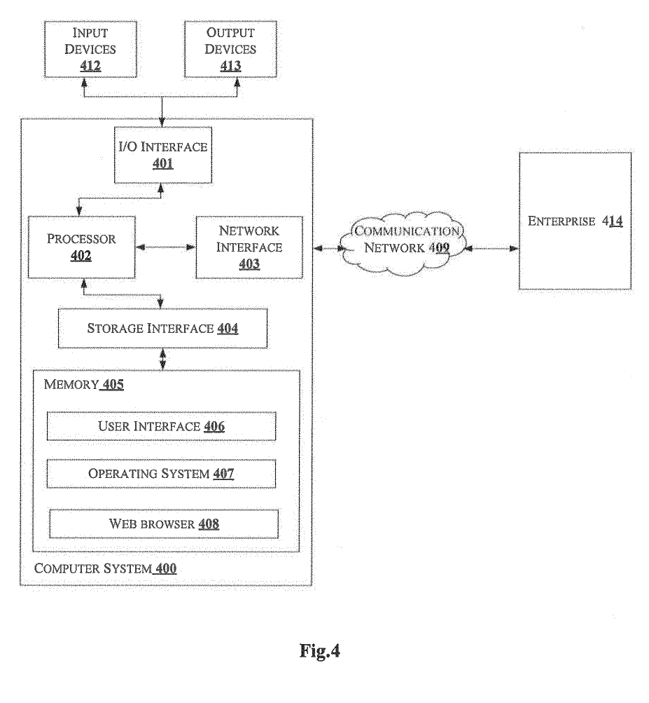

FIG. 4 illustrates a block diagram of an exemplary computer system 400 for implementing embodiments consistent with the present disclosure. In an embodiment, the computer system 400 is used to implement the server management system. The computer system 400 may comprise a central processing unit (“CPU” or “processor”) 402. The processor 402 may comprise at least one data processor for managing servers across plurality of data centres of an enterprise. The processor 402 may include specialized processing units such as integrated system (bus) controllers, memory management control units, floating point units, graphics processing units, digital signal processing units, etc.

The processor 402 may be disposed in communication with one or more input/output (I/O) devices (not shown) via I/O interface 401. The I/O interface 401 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 401, the computer system 400 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 400 consists of a server management system. The processor 402 may be disposed in communication with the communication network 409 via a network interface 403. The network interface 403 may communicate with the communication network 409. The network interface 403 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 409 may include, without limitation, a direct interconnection, local area network (LAN), wide area network (WAN), wireless network (e.g., using Wireless Application Protocol), the Internet, etc. Using the network interface 403 and the communication network 409, the computer system 400 may communicate with the enterprise 414. The network interface 403 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 409 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 402 may be disposed in communication with a memory 405 (e.g., RAM, ROM, etc. not shown in FIG. 3) via a storage interface 404. The storage interface 404 may connect to memory 405 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface 406, an operating system 407, web browser 408 etc. In some embodiments, computer system 400 may store user/application data 406, such as the data, variables, records, etc. as described in this disclosure. Such databases may be implemented as fault-tolerant, relational, scalable, secure databases such as Oracle or Sybase.

The operating system 407 may facilitate resource management and operation of the computer system 400. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Flat, Ubuntu, Kubuntu, etc.), IBM OS/2, Microsoft Windows (XP, Vista/7/8, etc.), Apple iOS, Google Android, Blackberry OS, or the like.

In some embodiments, the computer system 400 may implement a web browser 408 stored program component. The web browser 408 may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX, DHTML, Adobe Flash, JavaScript, Java, Application Programming Interfaces (APIs), etc. In some embodiments, the computer system 400 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

An embodiment of the present disclosure helps in managing the servers of the plurality of data centres by determining effectiveness of migration of servers across and within data centres.

An embodiment of the present disclosure provides a single view of server to server dependency mapping depicting the relationship between the servers.

The present disclosure provides an effective approach to part away with additional efforts and investment during transformation planning in data centres.

The present disclosure removes the dependency of any intrusive third party tools and also any additional licenses for managing servers.

An embodiment of the present disclosure provides a user friendly tool which can work on all operating systems and is independent of programming language.

The present disclosure provides the dependency mapping between the servers across the data centres.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral numerals:

| Reference | |
|---|---|
| Number | Description |
| 100 | Environment |
| 101 | Server management system |
| 103 | Enterprise |
| 105 | Communication network |
| 107 | I/O interface |
| 109 | Memory |
| 111 | Processor |
| 113 | Plurality of data centres |
| 115 | Servers |
| 116 | Server data extractors |
| 117 | Network devices |
| 118 | Network data extractors |
| 120 | Local relation builders |
| 200 | Data |
| 201 | Server related data |
| 203 | Network related data |
| 207 | Communication matrix data |
| 209 | Output data |
| 211 | Other data |
| 213 | Modules |
| 215 | Receiving module |
| 217 | Correlation module |
| 219 | What-if analyser module |
| 221 | Communication matrix generation module |
| 223 | Output module |
| 225 | Other modules |

What is claimed is:

1. A method for managing servers across plurality of data centres of an enterprise, the method comprising:
retrieve, by a server management system, server related data and network related data from a plurality of data centres;
correlating, by the server management system, the server related data with the network related data to obtain communication data;
generating, by the server management system, a communication matrix based on the communication data, wherein the communication matrix represents a relationship between the servers across the plurality of data centres; and
creating, by the server management system, one or more views of the servers of the plurality of data centres based on the identified communication matrix to manage the servers across the plurality of data centres.

2. The method as claimed in claim 1, wherein the server related data comprises at least one of information about communication paths used by the servers, connections between the servers, interfaces and current configurations of the servers, inter server dependencies and storage of the servers.

3. The method as claimed in claim 1, wherein the network related data comprises at least one of traffic flow pattern, routing data, firewall traffic, load balancer traffic, virtual switch and physical switch traffic which includes network device information and network connection information.

4. The method as claimed in claim 1, wherein generating the communication matrix comprises removing redundant data from the communication data.

5. The method as claimed in claim 1, further comprising assessing dependency mapping between servers with and across various data centres, bandwidth for the servers of the plurality of data centres based on the server related data and network related data.

6. The method as claimed in claim 1, wherein the one or more views comprises graphs showing the dependency view between the servers, data flow view and physical topology view of the servers of the plurality of data centre.

7. A server management system for managing servers across plurality of data centres of an enterprise comprising:
a processor; and
a memory communicatively coupled to the processor, wherein the memory stores processor instructions, which, on execution, causes the processor to:
retrieve server related data and network related data from a plurality of data centres;
correlate the server related data with the network related data to obtain communication data;
generate a communication matrix based on the communication data, wherein the communication matrix represents a relationship between the servers across the plurality of data centres; and
create one or more views of the servers of the plurality of data centres based on the identified communication matrix to manage the servers across the plurality of data centres.

8. The server management system as claimed in claim 7, wherein the server related data comprises at least one of information about communication paths used by the servers, connections between the servers, interfaces and current configurations of the servers, inter server dependencies and storage of the servers.

9. The server management system as claimed in claim 7, wherein the network related data comprises at least one of traffic flow pattern, routing data, network device information and network connection information.

10. The server management system as claimed in claim 7, wherein the processor generates the communication matrix by removing redundant data from the communication data.

11. The server management system as claimed in claim 7, wherein the processor further assesses bandwidth for the servers of the plurality of data centres based on the server related data and network related data.

12. The server management system as claimed in claim 7, wherein the one or more views comprises graphs showing the dependency view between the servers, data flow view and physical topology view of the servers of the plurality of data centre.

13. A non-transitory computer readable medium including instruction stored thereon that when processed by at least one processor cause a server management system to perform operation comprising:
retrieving server related data and network related data from a plurality of data centres;
correlating the server related data with the network related data to obtain communication data;
generating a communication matrix based on the communication data, wherein the communication matrix represents a relationship between the servers across the plurality of data centres; and
creating one or more views of the servers of the plurality of data centres based on the identified communication matrix to manage the servers across the plurality of data centres.

14. The medium as claimed in claim 13, wherein the instruction causes the processor to generate the communication matrix by removing redundant data from the communication data.

15. The medium as claimed in claim 13, wherein the instruction further causes the processor to assess bandwidth for the servers of the plurality of data centres based on the server related data and network related data.

16. The medium as claimed in claim 13, wherein the one or more views comprises graphs showing the dependency view between the servers, data flow view and physical topology view of the servers of the plurality of data centre.
